(19) United States
(12) Patent Application Publication
(10) Pub. No.: US 2016/0188817 A1
(43) Pub. Date: Jun. 30, 2016

(54) Real-Time Activity Coordination

(71) Applicant: Core Mobile Networks, Inc., Santa Clara, CA (US)

(72) Inventor: Chandra S. Tekwani, San Jose, CA (US)

(73) Assignee: Core Mobile Networks, Inc., Santa Clara, CA (US)

(21) Appl. No.: 14/985,195

(22) Filed: Dec. 30, 2015

Related U.S. Application Data
(60) Provisional application No. 62/097,790, filed on Dec. 30, 2014.

(51) Int. Cl. G06F 19/00; G06F 17/30

(52) U.S. Cl. CPC G06F 19/327; G06F 17/30595; G06F 19/322

(57) ABSTRACT

A context of a patient and contexts of a plurality of users are established. A workflow is selected based on the context of the patient. The workflow is traversed based on a changing of the context of the patient to determine appropriate actions. Relevant data to send for coordinating activities in real-time for providing care to the patient is determined based on the appropriate actions. A relevant user of the plurality of users is determined based on the contexts of the plurality of users and the appropriate actions. The relevant data is sent to the relevant user.

### CROSS-REFERENCE TO RELATED APPLICATIONS

This application claims the benefit of U.S. Patent Provisional Application No. 62/097,790, filed on Dec. 30, 2014, the entirety of which is hereby incorporated by reference.

### BACKGROUND

An area of ongoing research and development is in hospital and care center patient management. In particular, there exists needs for improving the overall efficiency of hospitals and care centers and minimizing the chances of readmission of a patient.

The foregoing examples of the related art and limitations related therewith are intended to be illustrative and not exclusive. Other limitations of the relevant art will become apparent to those of skill in the art upon reading the specification and studying of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

In various implementations, a context of a patient and contexts of a plurality of users are established. Further, in various implementations, a workflow is selected based on the context of the patient. In various implementations, the workflow is traversed based on a changing of the context of the patient to determine appropriate actions. Additionally, in various implementations, relevant data to send for coordinating activities in real-time for providing care to the patient is determined based on the appropriate actions. In various implementations, a relevant user of the plurality of users is determined based on the contexts of the plurality of users and the appropriate actions. In various implementations, the relevant data is sent to the relevant user.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for coordinating activities in real-time.

FIG. 2 depicts a diagram of a system for coordinating activities in real-time by acquiring and pushing data to users based on context.

FIG. 3 depicts a flowchart of an example of a method for coordinating activities in real-time based on context.

FIG. 4 depicts a diagram of an example of a system for engaging a patient based on context.

FIG. 5 depicts a diagram of an example workflow management system for managing workflows used in communicating with users based on context.

FIG. 6 depicts a diagram of an example context based data relevance determination system.

FIG. 7 depicts a flowchart of an example of a method for communicating with a patient according to a changing context of a patient using a workflow.

FIG. 8 depicts a flowchart of an example of a method for generating workflows for use in determining relevant data to send to relevant users based on context.

FIG. 9 depicts a flowchart of an example of a method for determining relevant data to send to relevant users based on contexts of users and a workflow.

### DETAILED DESCRIPTION

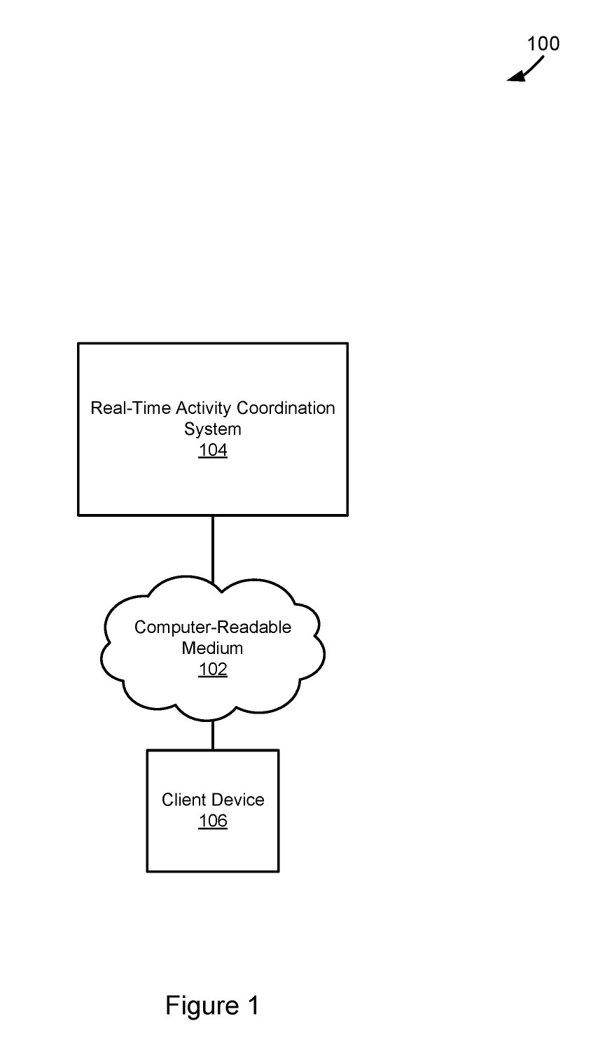

FIG. 1 depicts a diagram 100 of an example of a system for coordinating activities in real-time. The system of the example of FIG. 1 includes a computer-readable medium 102, a real-time activity coordination system 104, and a client device 106.

The real-time activity coordination system 104 and the client device 106 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, real-time activity coordination system 104, the client device 106, and other applicable systems, or devices described in this paper can be implemented as a computer system or parts of a computer system or a plurality of computer systems. A computer system, as used in this paper, can include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In a specific implementation, the real-time activity coordination system 104 functions to coordinate activities by sending and receiving data to and from client devices (e.g. client device 106) of users who carry out, or otherwise take part in, the coordinated activities. Depending upon implementation-specific or other considerations, the real-time activity coordination system 104 can coordinate activities related to health care. For example, activities coordinated by the real-time activity coordination system 104 can include examining a patient, diagnosing a patient, administering anesthesia to a patient, performing pre-operation activities in preparing a patient for surgery, performing surgery on a patient, and performing post-operation activities after a patient has had surgery.

In a specific implementation, the real-time activity coordination system 104 functions to generate a workflow of activities coordinated by the real-time activity coordination system 104. Depending upon implementation-specific or other considerations, the real-time activity coordination system 104 can create a workflow for activities undertaken in relation to healthcare. For example, the real-time activity coordination system 104 can create a workflow that includes, examining a patient to diagnose a condition, preparing the patient for surgery, administering anesthesia to the patient, performing surgery on the patient, and performing post-operation activities on the patient.

In a specific implementation, the real-time activity coordination system 104 functions to acquire data from various applicable systems. The real-time activity coordination system 104 can acquire data from client devices. For example, the real-time activity coordination system 104 can acquire data specifying that a patient has been checked in from a healthcare provider responsible for checking in a patient. The real-time activity coordination system 104 can also acquire data from systems or datastores external to the real-time activity coordination system 104. For example, the real-time activity coordination system 104 can acquire patient data for a patient from a previous hospital at which the patient visited. Depending upon implementation-specific or other considerations, data acquired by the real-time activity coordination system 104 can be used to generate a workflow that includes activities to be performed. For example, the real-time activity coordination system 104 can generate a workflow based on data identifying a diagnosis of a patient acquired from a client device used by the doctor.

In a specific implementation, the real-time activity coordination system 104 can acquire data indicating the completion of activities in a workflow as activities in the workflow are completed. Depending upon implementation-specific or other considerations, data indicating the completion of activities in a workflow from client devices of users who are actually performing the activities. For example, if a healthcare provider has completed performing pre-operation procedures on a patient, then the healthcare provider can input into a client device that they have completed performing the pre-operation procedures, and the real-time activity coordination system 104 can acquire data from the client device indicating that the pre-operation procedure has been performed.

In a specific implementation, the real-time activity coordination system 104 functions to determine which data is relevant to push to specific users based on a context of the data. Depending upon implementation-specific or other considerations, a context of data can include the identification of a person for whom activities are being performed and the characteristics of the activities being performed. For example, the context of data can include be based on a patient for which the acquired data is related. Specifically, if the data is a patient record for a patient, then the context can be an identification of the patient.

In a specific implementation, the real-time activity coordination system 104 functions to determine which data is relevant to push to specific users based on a context of a specific user. Depending upon implementation-specific or other considerations, a context of a specific user can include the identification of the user, the characteristics, specialties, or talents of a specific user, and the location of the specific user. For example, if a user is a doctor that is located on premises, the real-time activity coordination system 104 can push data to the doctor based on the fact that the doctor is on the premises. In another example, if a user is a doctor that specialized in a specific type of surgery that needs to be performed on a patient, then the real-time activity coordination system 104 can push data to the doctor about the patient based on the fact that the doctor specialized in the specific type of surgery that needs to be performed.

In a specific implementation, the real-time activity coordination system 104 functions to determine which data is relevant to push based on a context of a person for whom activities are being performed. Depending upon implementation-specific or other considerations, a context of a person for whom activities are being performed can include, the identification of the person, the location of the person, and the types of activities that are being performed for the person. For example, if the person is a patient who is currently located at a hospital, then the real-time activity coordination system 104 can push data to users associated with the hospital, such as doctors and nurses. In another example, if person is a patient for whom a specific operation will be performed, then the real-time activity coordination system 104 can push data to doctors who specialized in the specific operation that will be performed on the person.

In a specific implementation, the real-time activity coordination system 104 functions to determine what data to push to a user based on context and pushes the data to the user in real-time as the data is acquired. In one example, the real-time activity coordination system 104 determines what data to push to a user based on a context of data that is acquired in real-time as the data is acquired. In another example, the real-time activity coordination system 104 determines what data to push to a user based on a context of the user in real-time as the data is acquired. In a further example, the real-time activity coordination system 104 determines what data to push to a user based on a context of a user for whom activities are to be performed in real-time as the data is acquired.

In a specific implementation, the client device 106 functions to receive data pushed to a user by the real-time activity coordination system 104. In one example, a user uses the client device 106 to receive and view information pushed by the real-time activity coordination system 104. For example, if a user is a doctor, then the doctor can use the client device 106 to receive and view information related to a patient that has been assigned to a doctor. The client device 106 can be a mobile device that receives data through a wireless network to which the client device 106 is coupled. Additionally, the client device 106 can be a thin client or an ultra-thin client.

In a specific implementation, the client device 106 functions to generate data that the real-time activity coordination system 104 acquires based on input from a user. The client device 106 can be used by a user to input and subsequently generate data regarding data pushed to the user by the real-time activity coordination system 104. The data generated by the client device 106 can include data regarding the completion of activities by a user of the client device 106. For example, the data generated by the client device 106 can include that a healthcare provider has completed pre-operation activities for a patient.

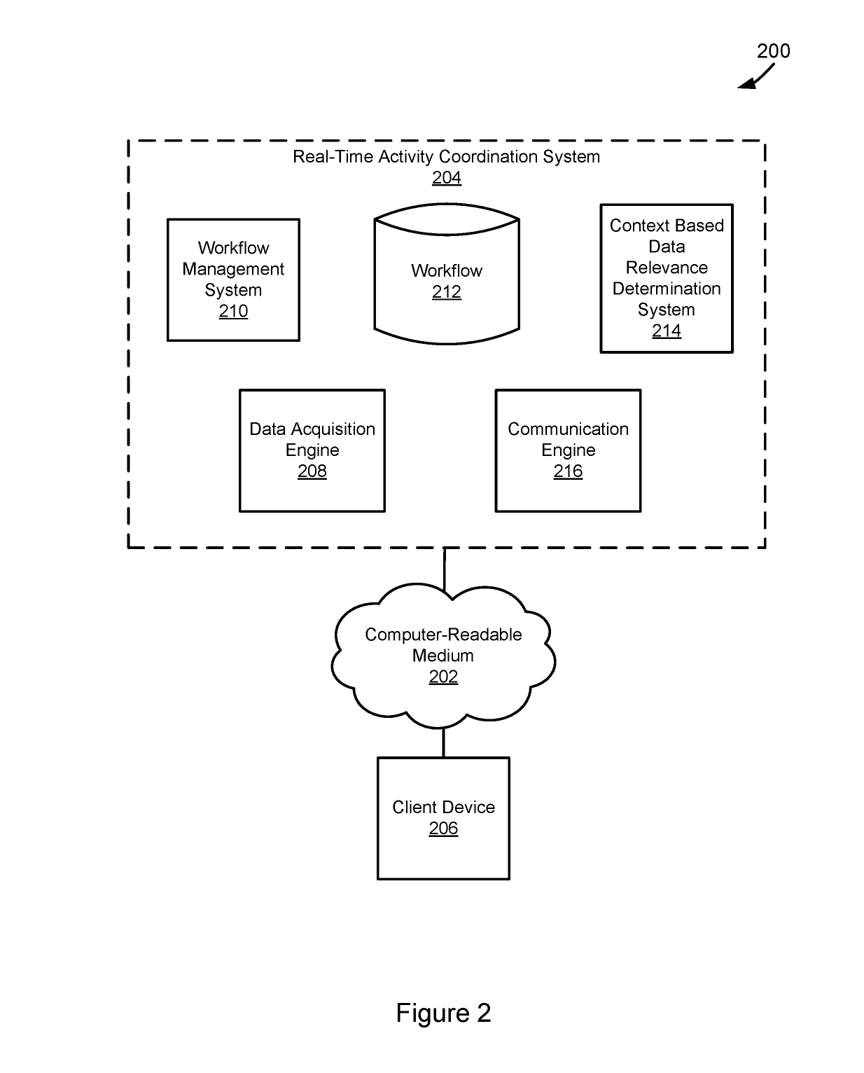

FIG. 2 depicts a diagram 200 of a system for coordinating activities in real-time by acquiring and pushing data to users based on context. The example system shown in FIG. 2 includes a computer-readable medium 202, a real-time activity coordination system 204, and a client device 206. In the example system shown in FIG. 2, the real-time activity coordination system 204 and the client device 206 are coupled to each other through the computer-readable medium 202.

In a specific implementation, the real-time activity coordination system 204 functions according to an applicable system for coordinating activities in real-time, such as the real-time activity coordination systems described in this paper. In coordinating activities in real-time, the real-time activity coordination system 204 can generate a workflow of the activities. Further, in coordinating activities in real-time, the real-time activity coordination system 204 can acquire and push data to users based on context.

In a specific implementation, the client device 206 functions according to an applicable device for sending and receiving data, such as the client devices described in this paper. As part of the client device 206 sending data, the real-time activity coordination system 204 can acquire data from the client device 206. As part of the client device 206 receiving data, the real-time activity coordination system can push data to the client device 206.

In the example system shown in FIG. 2, the real-time activity coordination system 204 includes a data acquisition engine 208, a workflow management system 210, a workflow datastore 212, a context based data relevance determination system 214, and a communication engine 216. In a specific implementation, the data acquisition engine 208 functions to acquire data from applicable systems or devices. In acquiring data, the data acquisition engine 208 can acquire data from systems external to the real-time activity coordination system 204 or the organization using the real-time activity coordination system 204. For example, the data acquisition engine 208 can collect patient records from another hospital that a patient previously visited. In another example, the data acquisition engine 208 can collect patient insurance information from an insurer of a patient. Further in acquiring data, the data acquisition engine 208 can acquire data from client devices (e.g. client device 206) that are coupled to the real-time activity coordination system 204. In acquiring data from a client device 206, the data acquisition engine 208 can acquire data indicating that a user has completed an activity. For example, the data acquisition engine 208 can acquire data from a client device 206 indicating that a healthcare provider who uses the client device 206 has completed performance of pre-operation activities on a patient.

In a specific implementation, the workflow management system 210 functions to generate a workflow. A workflow generated by the workflow management system 210 can include the activities that need to be performed and the order in which the activities need to be performed in achieving a goal. The workflow management system 210 can generate a workflow based on data acquired by the data acquisition engine 208. For example, the data acquisition engine 208 can acquire data indicating that a patient has checked in, and the workflow management system 210 can generate a workflow to diagnose the patient. In another example, the data acquisition engine 208 can acquire data indicating a diagnosis of a patient, and the workflow management system can generate a workflow of activities that need to be performed based on the diagnosis of the patient.

In a specific implementation, the workflow datastore 212 functions to store workflows. The workflow datastore 212 can store workflows generated by the workflow management system 210. Workflows stored in the workflow datastore 212 can include activities that need to be performed in achieving a common goal and the order in which the activities need to be performed. Workflows stored in the workflow datastore 212 can also include users assigned to complete or participate in activities performed in achieving a common goal.

In a specific implementation, the context based data relevance determination system 214 functions to determine which data is relevant to specific users based on a context of the specific users. Depending upon implementation-specific or other considerations, the context based data relevance determination engine 214 can determine which data acquired by the data acquisition engine 208 is relevant to specific users based on a context of the specific users. Further depending upon implementation-specific or other considerations, the context based data relevance determination engine 214 can determine which data generated by the real-time activity coordination system 204, such as data about a workflow generated by the workflow management system 210, is relevant to specific users based on a context of the specific users. In determining which data is relevant to specific users based on a context of the specific users, the context based data relevance determination system 214 can use the characteristics of a specific user to determine which data is relevant to the specific user. For example, if a user is a doctor who specializes in a procedure to be performed on a patient, then the context based data relevance determination system 214 can determine that data related to the patient is relevant to the doctor. Further in determining which data is relevant to specific users based on a context of the specific users, the context based data relevance determination system 214 can use the identity of a specific user to determine which data is relevant to a specific user.

In a specific implementation, the context based data relevance determination system 214 functions to determine which data is relevant to specific users based on a context of a person for whom activities are being performed. Depending upon implementation-specific or other considerations, the context based data relevance determination engine 214 can determine which data acquired by the data acquisition engine 208 is relevant to specific users based on a context of a person for whom activities are being performed. Further depending upon implementation-specific or other considerations, the context based data relevance determination engine 214 can determine which data generated by the real-time activity coordination system 204, such as data about a workflow generated by the workflow management system 210, is relevant to specific users based on a context of a person for whom activities are being performed. In determining which data is relevant to specific users based on a context of a person for whom activities are being performed, the context based data relevance determination system 214 can use the location of a person for whom activities are being performed to determine which data is relevant to a specific user. For example, if a person for whom activities are being performed is located in a hospital, then the context based data relevance determination system 218 can determine that data about the person is relevant to doctors and healthcare providers associated with the hospital. Further in determining which data is relevant to specific users based on a context of a person for whom activities are being performed, the context based data relevance determination system 214 can use the characteristics of the activities that are or will be performed to determine which data is relevant to a specific user. For example, if a person will have a specific operation performed on them, then the context based data relevance determination system 214 can determine that data about the person is relevant to doctors and healthcare providers who specialize in the specific operation.

In a specific implementation, the communication engine 216 functions to push data to client devices (e.g. client device 206). In pushing data to client devices, the communication engine 216 can push data based on a determination of what data is relevant to specific users made by the context based data relevance determination system 214. Further in pushing data to client devices, the communication engine 216 can push data to client devices that are associated with or used by specific users for whom the context based data relevance determination system 214 determines data is relevant. For example, if the context based data relevance determination system 214 determines that patient information is relevant to a doctor, then the communication engine 216 can push the patient information to a client device used by or associated with the doctor. The communication engine 216 can push acquired data to client devices in real-time as it is acquired by the data acquisition engine 208. Additionally, the communication engine 216 can push data generated by the real-time activity coordination system 204 to client devices in real-time as the data is generated. For example, the communication engine 216 can push data related to workflows generated by the workflow management system 210 to client devices as the data related to workflows is generated by the workflow management system 210.

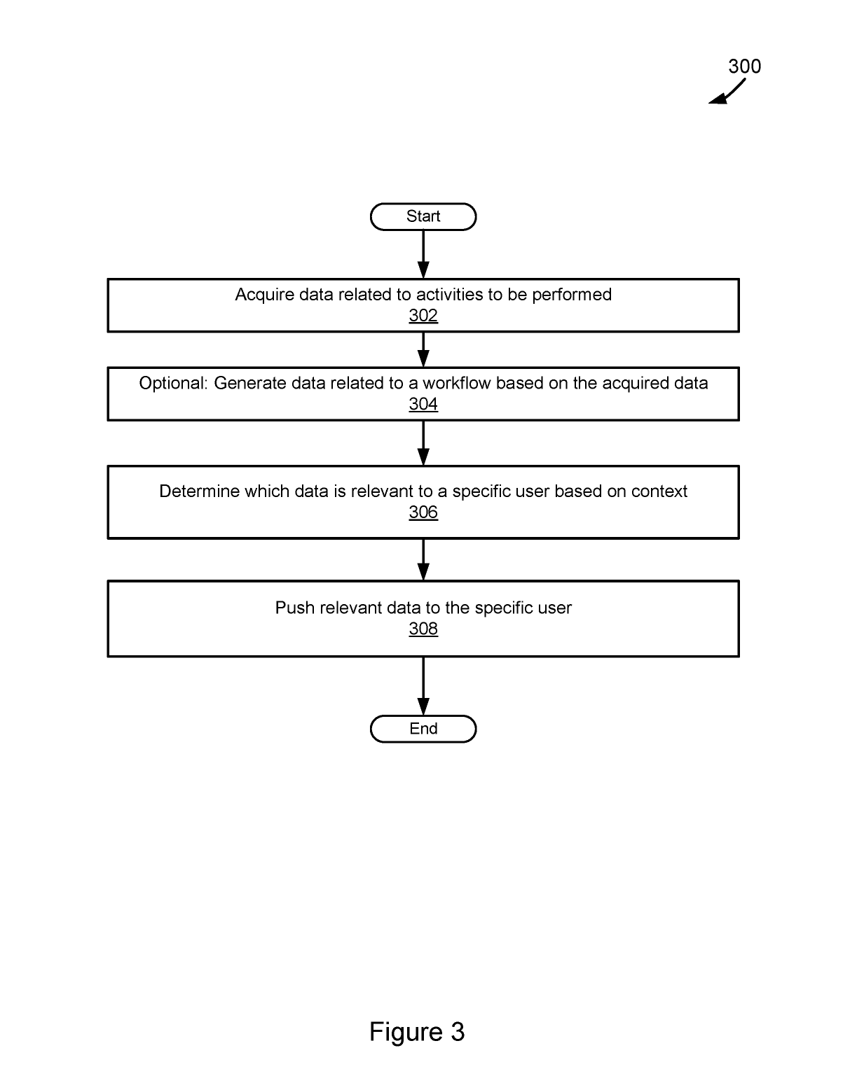

FIG. 3 depicts a flowchart 300 of an example of a method for coordinating activities in real-time based on context. The example flowchart 300 begins at module 302, where data related to activities to be performed is acquired. In one example, acquired data relates to activities to be performed on a patient in receiving healthcare. For example, acquired data can be patient records from a previous hospital or a previous hospital visit. In another example, acquired data relates to a diagnosis of a patient and subsequent activities that need to be performed based on the diagnosis. Data can be acquired from client devices of specific users associated with activities that are or will be performed. In one example, data indicating that an activity has been performed can be acquired from a client device of a specific user who performed the activity. For example, if an activity is checking a patient in, and the patient has been checked in by a healthcare provider, then data indicating that the patient has been checked in by the healthcare provider can be collected from a client device used by the healthcare provider if the healthcare provider inputs into the client device that the patient has been checked in by the healthcare provider.

The example flowchart 300 optionally continues to module 304, where data related to a workflow is generated based on the acquired data. Data related to a workflow can include the activities that need to be performed and the order in which the activities need to be performed. In one example, data related to a workflow can include healthcare activities that need to be performed on a patient based on a diagnosis of the patient. Specifically, if data acquired at module 302 is a diagnosis of a patient, then data related to a workflow that includes the activities that need to be performed based on the diagnosis of the patient can be generated.

The example flowchart 300 continues to module 306, where it is determined which data is relevant to a specific user based on context. The data that is determined to be relevant or not can be either or both data related to activities to be performed that is acquired at module 302, or data related to a workflow generated at module 304. Depending upon implementation-specific or other considerations, it is determined which data is relevant to a specific user based on a context of a specific user. For example, if a user specializes in an operation to be performed on a patient, then data related to the patient is determined to be relevant. Further depending upon implementation-specific or other considerations, it is determined which data is relevant to a specific user based on a context of a person for whom activities are being performed. For example, if a person has been checked into a hospital to meet with a doctor, then data about the patient can be determined to be relevant to doctors and healthcare providers associated with or in the hospital.

The example flowchart continues to module 308, where relevant data is pushed to specific users. Data is determined to be relevant to specific users at module 306 based on context. In pushing relevant data to specific users, the relevant data can be sent to a client device associated with or used by a specific user. For example, if the specific user is a doctor, then the relevant data can be sent to a mobile device, such as a smart phone, used by or associated with the doctor.

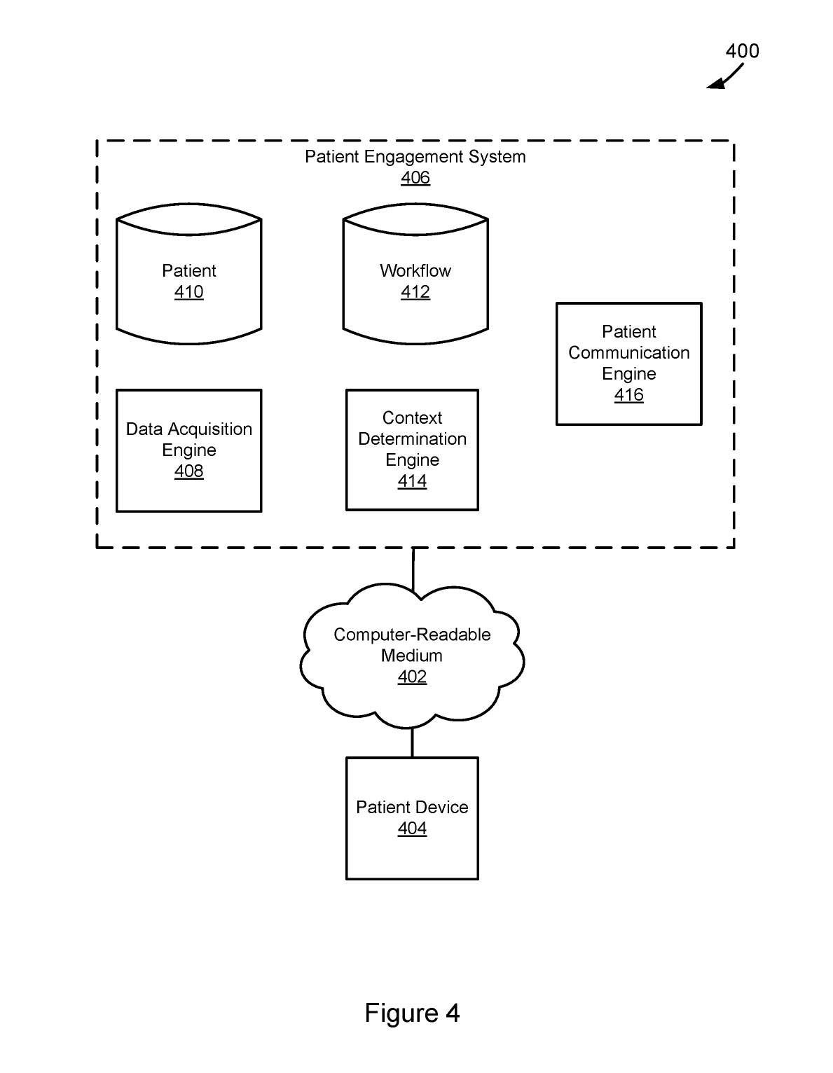

FIG. 4 depicts a diagram 400 of an example of a system for engaging a patient based on context. The example system shown in FIG. 4 includes a computer-readable medium 402, a patient device 404, and a patient engagement system 406. The patient device 404 and the patient engagement system 406 are coupled to each other through the computer-readable medium 402.

The patient device 404 functions according to an applicable device for allowing a patient to interact with the various systems described in this paper, such as the client devices described in this paper. In various implementations, the patient device 404 can be used by the patient to input information. For example, the patient device 404 can be used to input their symptoms or whether they took their medication. In various implementations, the patient device 404 can be used by the patient to receive information. In another example, the patient device 404 can be used to check-in for a doctor appointment. For example, the patient device 404 can be used to send surveys to a patient or ask a patient about symptoms they are experiencing. Depending upon implementation-specific or other considerations, the patient device 404 can be implemented in part as a kiosk at a hospital or an ambulatory care center. For example, the patient device 404 can be a kiosk at an ambulatory care center that is used to notify ambulatory care professionals that a patient has checked in for their appointment.

The patient engagement system 406 functions to communicate with a patient based on context. The patient engagement system 406 can function to reduce readmission rates of patients. The patient engagement system 406 can acquire data from a patient as part of communicating with a patient. The patient engagement system 406 can gather patient data used in determining, at least in part, a context. Patient data can include applicable data related to providing treatment to a patient. For example, patient data can include an age, gender, lifestyle, and location of a patient, symptoms a patient is experiencing, follow up care information or symptoms of a patient, and completed surveys of a patient. The patient engagement system 406 can determine a context related to a patient based on retrieved patient data. For example, the patient engagement system 406 can determine that a patient is at risk of diabetes based on a lifestyle of a patient. The patient engagement system 406 can communicate with a patient according to a determined context and a workflow. A workflow can include triggers or conditions that cause a workflow to change and/or dictate communication with a user, e.g. a patient based on a context. For example, a workflow can include a condition that if a patient does not take their medication then the patient should be reminded to take their medication. A workflow can be selected to apply to a patient based on a context. For example if context indicates a patient is 60 years old and has a heart condition, then a workflow unique to patients who are 60 years old with the heart condition can be applied to the patient. Depending upon implementation-specific or other considerations, a workflow can be created based on a context and medical rules. For example if medical rules for a patient specify to implement a specific care plan if a patient is over 60 years old and a diabetic, then a workflow can be created for diabetics over 60 years old that implements the specific care plan.

In a specific implementation, the patient engagement system 406 functions to communicate with a patient in providing acute care. In various implementations, the patient engagement system 406 can communicate with a patient in providing pre-acute care to the patient. For example, the patient engagement system 406 can remind a patient to refrain from eating or drinking before their procedure. In various implementations, the patient engagement system 406 can communicate with a patient in providing acute care to the patient. For example, the patient engagement system 406 can ask a patient whether they ate or drank anything within 24 hours before a procedure is performed. In various implementations, the patient engagement system 406 can communicate with a patient in provided post-acute care to the patient. For example, the patient engagement system 406 can follow up with a patient regarding their healing from a procedure.

In a specific implementation, the patient engagement system 406 functions to be used in testing of a drug in trials. In being used in testing of a drug in trials, the patient engagement system 406 can send and receive surveys to and from a user participating in trials. Surveys gathered by the patient engagement system 406 can be used to clear a drug for use in treatment. For example, surveys can be used to generate symptoms data for use in clearing a drug for use in treatment.

The patient engagement system 406 shown in FIG. 4 includes a data acquisition engine 408, a patient datastore 410, a workflow datastore 412, a context determination engine 414, and a patient communication engine 416. The data acquisition engine 408 functions to gather patient data from a patient. Depending upon implementation-specific or other considerations, the data acquisition engine 408 can gather patient data from a patient by querying the patient. For example, the data acquisition engine 408 can ask a patient their age and their symptoms. Further depending upon implementation-specific or other considerations, the data acquisition engine 408 can gather patient data according to a context and/or a workflow. For example if a workflow is applied to a patient, e.g. based on a context of a patient, and a context of a patient indicates that the patient is experiencing specific symptoms, then the data acquisition engine 408 can gather specific data from the patient, as indicated by rules in the workflow based upon the specific symptoms.

The patient datastore 410 functions to store gathered patient data for a patient. Patient data stored in the patient datastore 410 can be organized into a patient profile specific to a patient. For example, patient data stored in the patient datastore 410 can indicate symptoms a patient is experiencing over time. Depending upon implementation-specific or other considerations, patient data stored in the patient datastore 410 can be gathered according to a context and/or a workflow. For example if a workflow is applied to a patient, e.g. based on a context of a patient, and a context of a patient indicates that the patient is experiencing specific symptoms, then specific patient data from the patient, as indicated by rules in the workflow based upon the specific symptoms, can be stored in the patient datastore 410.

The workflow datastore 412 functions to store workflow data indicating specific workflows to apply to a patient. A workflow can include triggers or conditions that cause a workflow to change and/or dictate communication with a user, e.g. a patient based on a context. For example, a workflow can include a condition that if a patient does not take their medication then the patient should be reminded to take their medication. A workflow can be specific to a context of a user. For example, if a user is 60 years old with diabetes, then a workflow can be specific to a 60 year old with diabetes to include treatment regiments for 60 year old patients with diabetes. In various implementations, a workflow can be created according to medical rules. For example if medical rules specify a treatment plan for a 60 year old who has suffered a stroke, then a workflow can be created according to the treatment plan for 60 year old patients who have suffered a stroke.

The context determination engine 414 functions to determine a context of a patient. The context determination engine 414 can determine a context of a patient based on patient data gathered for the patient. For example, if patient data indicates specific symptoms that a patient is experiencing in taking a medication, then the context determination engine 414 can determine that a patient is having an adverse reaction to the medication. In another example if patient data indicates that a patient is a 60 year old diabetic, then the context determination engine 414 can determine a context of the patient is a 60 year old diabetic. In various implementations, the context determination engine 414 can determine a changing context of a patient in real-time based, at least in part, on a workflow. For example if a workflow specifies that if a patient is experiencing certain symptoms that they are having an adverse reaction to medication, and if patient data indicates that the patient is experiencing the certain symptoms, then the context determination engine 414 can determine a context for the patient that they are having an adverse reaction to the medication.

Table 1, illustrated below, lists examples of parameters that can form contexts of users, as used in this paper. The parameters can solely form a context or combinations of parameters can form a context.

TABLE 1
A. General Information
Patient Name
Patient Date of Birth
Patient Gender
Patient MRN
Patient SS#
Address, home tel#, mobile tel# & email
B. Procedure & Physician Information
Procedure name and risk
Date of procedure
Surgeon Name
PCP Name
PCP Mount Sinai Affiliated (Y/N)
MD providing medical clearance
Consult(s) Needed
Consults Obtained
Unused entry for now
C. Insurance Information
Primary Insurance
Secondary Insurance
Patient co-pay/payment
Financing
D. Clinical Information
History & Physical (date, pdf)
SMA-7 (date, number 1 to number 7) (Na, K+, CO2, Cl, BUN, Cre, Glu)
ASA (1 to 5)
BMI (date, number)
POMAF (date, pdf)
CBC (date, number)
Metabolic Panel (date, number 1 to 6) (optional/redundant, if SMA-7)
UA (date, number)
PT/INR/APTT (date, number, number)
EKG (date, report, pdf)
Type & Screen (date, letter, number)
urine toxicology screen
CXR (date, number)
LFT's (AST/ALT) (date, number, number)
PT/T (date, number)
myocardial stress test/cardiac catheterization
cervical MRI
echocardiogram
Documentation of type of pacemaker/AICD/and recent check
HIV RNA viral load/CD4/CD8 count
Pregnancy Test
Thyroid function Tests (TSH, T4, T3)
Head CT
Pulmonary Function Tests
HgA1C
E. Medical Clearance
HIV
Diabetes
Smoking
Liver disease (hepatitis, cirrhosis, alcoholism)
Kidney disease (chronic kidney disease, ESRD)
Significant Lung disease
Cancer - Radiation
Cancer - Chemotherapy
Coagulopathies
Heart disease - CAD
Diuretics - HCTZ, Lasix
Steroids - Prednisone
Blood thinners - Coumadin
Drug levels - Digoxin
Drug levels - Lithium
Drug levels - Dilantin
Cancer - Adriamycin
thyroid dysfunction
hx of cervical spinal stenosis-symptoms with neck extension
hx of mrsa
symptomatic heart murmur (CP/SOB/syncope)
hx of cardiomyopathy/CHF
hx of pacemaker/AICD
morbid obesity (BMI > 40)
OSA +/− CPAP
History of previous blood transfusions
illicit drug use
F. Clinical Information
Carotid Ultrasound/CT angio
Holter monitor results
sleep study
Heart rate
Blood pressure
oxygen saturation
type and crossmatch
medicine consult
cardiology consult
hematology consult
neurosurgical consult
AICD RN (to turn device off)
neurology consult
serum albumin
G. Medical Clearance
C-spine Xrays in flexion and extension
hx of congenital heart disease (repaired/unrepaired)
syncopal episode/Transient ischemic attack (TIA)
cerebrovascular disease
Hypertension (HTN)
blood thinners: factor Xa inhibitors
antiplatelet medications
rheumatoid arthritis
brain tumor
painful urination
heart murmur
arrythmia (a.fib, SVT, VT)
peripheral vascular disease.
anemia, hemoglobinopathy
Thrombocytopenia
Ace inhibitors/ARB's
hx of easy bruising, excessive blood loss with surgery
Hyperlipidemia

The patient communication engine 416 functions to communicate with a patient based on a determined context of a patient. The patient communication engine 416 can communicate with a patient according to a workflow. For example if a workflow indicates to send a survey to a patient daily as part of a drug trial, then the patient communication engine 416 can send the survey to the patient daily. In various implementations, the patient communication engine 416 can communicate with a patient according to both a workflow and a determined context of a patient. For example, if a workflow indicates that a patient should seek immediate medical attention if they are experiencing certain symptoms, and a context of the patient indicates that they are experiencing the certain symptoms, then the patient communication engine 416 can send a message to the patient advising them to seek immediate medical attention.

In a specific implementation, the patient communication engine 416 functions to determine a specific workflow to apply to a patient based on a context of a patient. For example, if a context of a patient indicates that the patient is a 60 year old diabetic, then the patient communication engine 416 can determine to apply a workflow specific to 60 year old diabetics to the patient. In various implementations, the patient communication engine 416 can traverse through the workflow and different decision routes within a workflow based on an ever changing context of a patient. For example, if a context of a patient changes to include that the patient is experiencing specific symptoms, then the patient communication engine can proceed down a decision route of the workflow based on the patient is experiencing the specific symptoms and determine from the decision route appropriate actions. Further in the example, the patient communication engine 416 can communicate with the patient according to the decision routes within the workflow that the patient communication engine 416 traverses according to the ever changing context of the patient.

In an example of operation of the example system shown in FIG. 4, the data acquisition engine 408 functions to gather patient data from a patient using the patient device 404. In the example of operation of the example system shown in FIG. 4, the patient datastore 410 stored patient data gathered by the data acquisition engine 410. Further, in the example of operation of the example system shown in FIG. 4, the workflow datastore 412 stores workflow data indicating workflows to apply to patients based on contexts of the patient. In the example of operation of the example system shown in FIG. 4, the context determination engine 414 determines a context of the patient based, at least in part, on patient data stored in the patient datastore 410. Additionally, in the example of operation of the example system shown in FIG. 4, the patient communication engine can select a workflow to apply to the patient based on the context determined by the context determination engine 414 and workflow data stored in the workflow datastore 412, and subsequently communicate with the patient according to the workflow and an ever changing context of the patient.

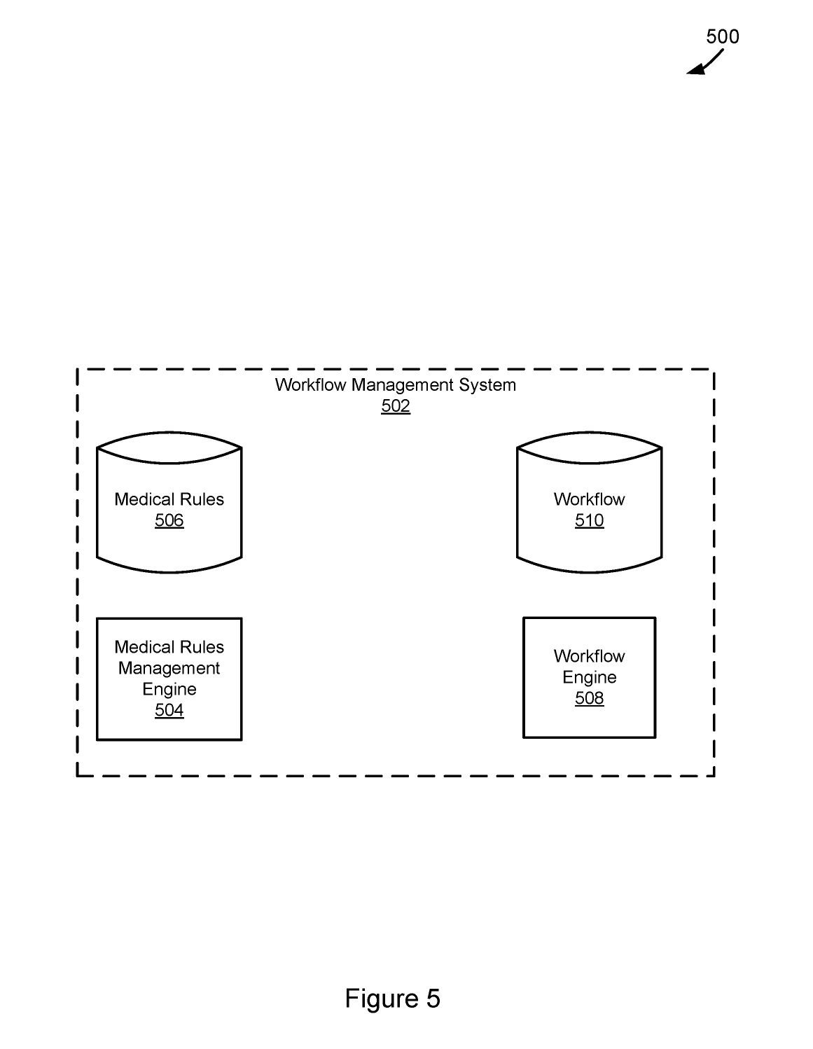

FIG. 5 depicts a diagram 500 of an example workflow management system 502 for managing workflows used in communicating with users based on context. The workflow management system 502 functions according to an applicable system for managing a workflow, such as the workflow management systems described in this paper. The workflow management system 502 can function to gather and organize medical rules. For example the workflow management system 502 can gather and organize medical rules according to specific contexts of a patient. The workflow management system 502 can generate workflows specific to contexts of patients using medical rules. For example, if medical rules indicate the steps for performing a surgery on a patient, then the workflow management system 502 can generate a workflow to indicate the steps for performing a surgery on a patient. A workflow can include events or conditions that trigger traversal of different decision routes within the workflow based on varying contexts of a patient. For example, a workflow can indicate that if a patient is experiencing specific symptoms, a context of the patient, then the patient should be advises to seek immediate medical attention, a decision route.

The example workflow management system 502 shown in FIG. 5 includes a medical rules management engine 504, a medical rules datastore 506, a workflow engine 508, and a workflow datastore 510. The medical rules management engine 504 functions to manage medical rules for creating workflows. In managing medical rules, the medical rules management engine 504 can gather medical rules to create a dictionary medical rules. The medical rules management engine 504 can gather medical rules from an applicable source. Depending upon implementation-specific or other considerations, the medical rules management engine 504 can gather medical rules from a public source. For example, the medical rules management engine 504 can gather medical rules from an encyclopedia of medicine, accessed through the Internet. Further depending upon implementation-specific or other considerations, the medical rules management engine 504 can gather medical rules specific to a care provider or organization. For example, the medical rules management engine 504 can query an acute care provider to determine their specific procedures in providing acute care.

The medical rules datastore 506 functions to store medical rules data indicating a medical rules dictionary used in generating workflows. Medical rules data stored in the medical rules datastore 506 can be specific to a care provider or an organization. For example, medical rules data stored in the medical rules datastore 506 can indicate specific procedures an acute care provider follows in providing acute care. In another example, medical rules data stored in the medical rules datastore 506 can indicate specific intake procedure a hospital follows in admitting patients. Table 2, reproduced below, illustrates example medical rules that can form a medical rules dictionary.

TABLE 2
H&P (#16) must be within 30 days of surgical date (#8)
If patient is over 65 (#2) they should have an EKG (#25) done within one year of the day of
surgery (#8)
For Diabetics (#32) check a finger stick blood sugar (in addition to serum glu (17) on the day of
surgery (#8), also check a CBC, SMA-7, HgA1C prior to the day of surgery (17, 21, 70)
For menstruating females (#3) check a pregnancy (#33) test on the day of surgery (#8) or have
them sign a form saying they are not pregnant.
For patients with hepatic disease (#34) check CBC (#21), PT/T (#30), SMA-7 (#17), LFT's (#29)
For patients with renal disease (chronic kidney disease) (#35) check CBC (#21), SMA-7 (#17).
For renal patients (#35) on dialysis check a serum potassium (#17) on the day of surgery, also
check CBC, SMA-7, PT/T prior to the day of surgery (21, 17, 30)
For patients whose surgery (#7) involves possible blood loss over 500 ml, have a type and screen
(#26) done at the hospital where the surgery will be performed within 3 days of the surgery date
(#8)
For patients who are having thoracic surgery (#7), check a CXR (#28); For patients with
significant lung disease (36) or who are PPD positive without a hx of a negative CXR or prior
treatment check a CXR (28)
For patients having chemotherapy (#38) check CBC (#21), SMA-7 (#17). If they are receiving the
chemotherapy drug Adriamycin (#47), do an EKG (#25) and LFT's (#29).
For patients currently receiving radiation therapy (#37) check CBC (#21). If the radiation therapy
is to the chest also do an EKG (#25) and CXR (#28).
For Bleeding disorders (#39) check CBC (#21) and PT/T (#30) and obtain perioperative
recommendations from hematology or patient's PCP.
Neonates (younger than 1 month) (#2) need a CBC (#21)
For patients on diuretics (#41) check SMA-7 (#17).
For patients receiving Digoxin (#44) check Digoxin level, SMA-7 (#17) and do an EKG (#25)
For patients on long term systemic steroids (#42) check SMA-7 (#17)
For patients who are on Coumadin (#43) check CBC (#21), PT/T (#30) and obtain perioperative
recommendations from patient's PCP or Cardiologist.
For patients who are on Dilantin (#46) check Dilantin level (#46)
For patients on Lithium (#45) check a Lithium level (#45)
For patients with a hx of thyroid dysfunction (48), order TFT's (67), SMA-7 (17)
For patients with a hx of HIV (31) check RNA viral load, CD4 and CD8 count (65).
For patients with a hx of OSA (55) have them bring their CPAP machine with them to the
hospital (or they can bring their settings and MSBI can provide one)
For patients with a hx of rheumatoid arthritis (98) inquire about atlantoaxial instability and check
neck x-rays in flexion and extension if positive. (91)
For patients with a hx of an un-resected brain tumor (99) get results of last head CT (68), consider
neurosurgery consult. ( )
For patients with a pacemaker and/or AICD (53), obtain make and model and date of last phone
interrogation (64), consider AICD nurse to turn off device ( )
For patients with painful urination (100) or for patients having urologic procedures (7) obtain a
urinalysis (25)
For patients with a hx of neurologic symptoms with neck extension or hx of cervical myelopathy
or radiculopathy (49), obtain a copy of their last cervical MRI (62)
For patients with a hx of congenital heart disease (92) with repair obtain documentation of the
type of repair if unknown by patient or do an echo/cardiology consult (63)
For patients with a hx of a TIA (93)in the last 6 months obtain a copy of the carotid ultrasound
or the CT angiogram (71)
For patients with a hx of a syncopal episode (93) within the last 6 months obtain a copy of the
evaluation and final diagnosis.
For patients with a hx of a heart murmur (101) obtain a copy of most recent echocardiogram. If
no echocardiogram has been done, inquire about symptoms of CP/SOB/syncope. If heart
murmur symptomatic (CP/SOB/syncopal episodes) obtain a cardiology consult.
For patients with a hx of atrial fibrillation, atrial flutter, SVT, (102) obtain an EKG (25)
plus/minus a copy of any Holter monitoring (72) done in the past. Atrial fibrillation rate must be
less than 100 beats per minute (74).
For patients with a recent hx of illicit drug use (cocaine, methamphetamine, MDMA) (57) obtain
a urine toxicology screen on the day of surgery (27).
For patients with a hx of significant lung disease obtain a copy of most recent pulmonary
function tests (69) if available.
For patients having thoracic surgery involving lung resection obtain a copy of most recent
pulmonary function tests. If not done in the past 6 months obtain PFT's (69).
For patients with an active upper respiratory infection, with or without a hx of asthma, on the
day before surgery have them call their surgeon.
For patients with CAD (40), PVD (peripheral vascular disease) (103), CVD (cerebral vascular
disease (94)), morbid obesity (BMI > 40) (54) obtain a preoperative EKG (25)
Consider an EKG (25) for ASA3 (18) patients undergoing intermediate risk surgery (intra-
abdominal, intrathoracic surgery) (7)
For patients with a hx of anemia (103) or hemoglobinopathy (103) obtain a Hg/Hct (21)
For patients with a hx of thrombocytopenia (104) obtain a CBC (21)
For anemic (103) patients having surgery possibly involving > 500 ml (7) of blood loss order a
Type and Crossmatch for 2 units of packed red blood cells (PRBC's) (77)
For alcoholic patients (34) check LFT's (29), PT/T. (30)
For patients taking ARB's, or ACE inhibitors check (106) an SMA-7 (17)
For patients undergoing high risk surgery (7) check CBC (21), SMA-7 (17)
For patient with a hx of easy bruising or excessive blood loss with surgery (107) check a
CBC (21), PT/T (30) and if abnormal obtain a hematology consult (80)
For patients with one or more risk factors (HTN (95), CAD, (40) hx of smoking (33),
Diabetes (32), HLD (108), renal disease (35)) undergoing intermediate risk surger(7)y, order an
EKG (25)
For BMI > 40 (54) consider preoperative sleep study (73)
For patients with a history of cirrhosis order SMA7 (17), CBC (21), LFT's (29), serum
Albumen (84)
For patients with a systolic blood pressure (SBP) greater than 200 and a diastolic blood pressure
(DBP) greater than 110 (#75) obtain a medical consult control of blood pressure (78), (12)
For patients with a resting heart rate (HR) greater than 110 (#75), obtain TFT's (67), CBC (21),
medicine consult (78), (12)
For patients on Faxtor Xa inhibitors e.g. Xarelto (96) obtain recommendations for holding the
medication perioperatively (12)

The workflow engine 508 functions to generate a workflow for use in communicating with users based on context. The workflow engine 508 can generate a workflow from medical rules. For example, the workflow engine 508 can determine decision routes and conditions or events, corresponding to different contexts that trigger traversal of the different decision routes from medical rules. Further in the example, the workflow engine 508 can build a workflow using the determined decision routes and conditions or events. The workflow engine 508 can associate a workflow with a context. For example, the workflow engine 508 can associate a workflow with patients who are over 60 and having surgery, such that the workflow can be followed for patient who are over 60 and having surgery. The workflow engine 508 can determine a context to associate a workflow with based on medical rules.

The workflow datastore 510 functions to store workflow data indicating workflows for use in communicating with users based on context. Workflow data stored in the workflow datastore 510 can include decision routes and conditions or events, corresponding to different contexts, that trigger traversal of the different decision routes within a workflow. Workflow data stored in the workflow datastore 510 can include a context associated with a specific workflow. For example if a workflow is for 60 year old diabetics, then workflow data stored in the workflow datastore 510 can indicate that the workflow is to be applied to 60 year old diabetics.

In an example of operation of the example system shown in FIG. 5, the medical rules management engine 504 builds a medical rules dictionary stored as medical rules data in the medical rules datastore 506. In the example of operation of the example system shown in FIG. 5, the workflow engine 508 generates a workflow based on the medical rules dictionary indicated by medical rules data stored in the medical rules datastore 506. Further, in the example of operation of the example system shown in FIG. 5, the workflow generated by the workflow engine 508 is stored as workflow data in the workflow datastore 510. In the example of operation of the example system shown in FIG. 5, the workflow engine 508 associates the workflow with a context using the medical rules dictionary.

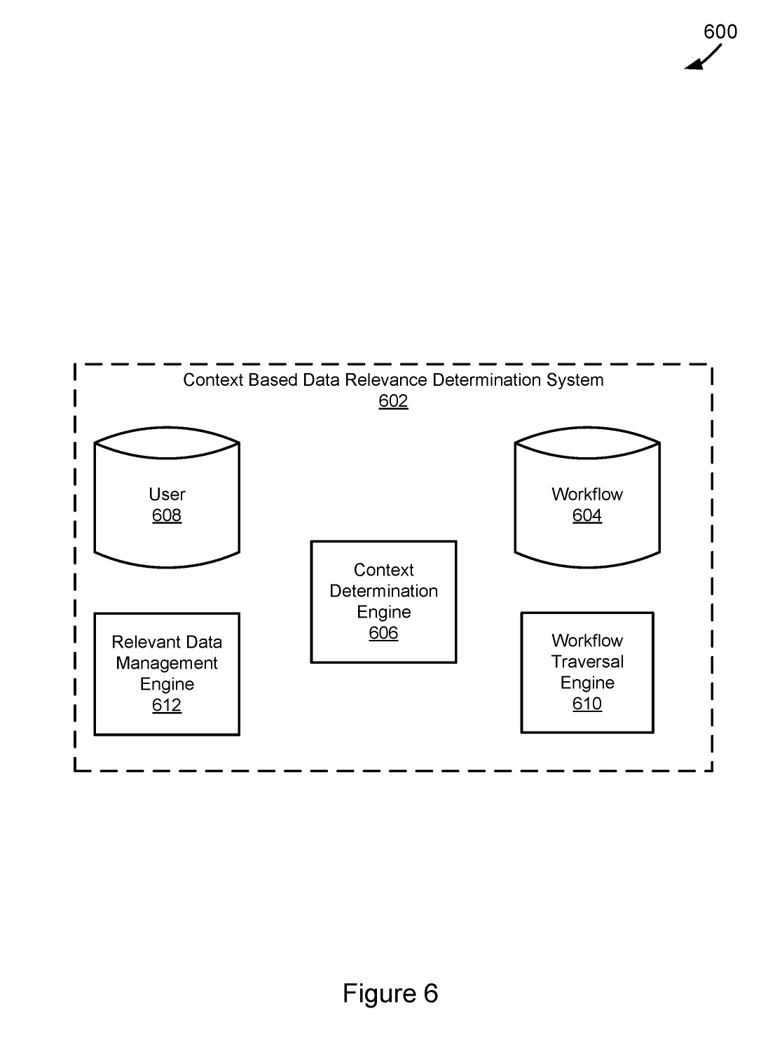

FIG. 6 depicts a diagram 600 of an example context based data relevance determination system 602. The context based data relevance determination system 602 functions according to an applicable system for determining data to push to a user according to a context and a workflow, such as the context based data relevance determination systems described in this paper. In various embodiments, the context based data relevance determination system 602 can determine a contexts of users and patients. For example, the context based data relevance determination system 602 can determine a context of a patient that the patient is done having an acute care procedure performed on them. In another example, the context based data relevance determination system 602 can determine a context of staff indicating locations of staff within an acute care center.

In a specific implementation, the context based data relevance determination system 602 functions to traverse a workflow using determined contexts. In traversing a workflow using a context, the context based data relevance determination system 602 can determine decision routes to follow according to the context. For example, if a context of a patient indicates that a patient is done having a procedure performed on them, then the context based data relevance determination system 602 can traverse down a decision route for removing the patient from the surgery room. In traversing a workflow based on a context, the context based data relevance determination system 602 can determine relevant data to push to users or patients according to activities to perform, as included as part of the workflow. For example, if a patient is done having a procedure performed on them and a decision route of a workflow indicates to perform the activity of taking the patient to the post operation room, then the e context based data relevance determination system 602 can push data to staff alerting them to move the patient to the post operation room. In various implementations, the context based data relevance determination system 602 can determine specific users to push relevant data to based on a context of the specific users. For example, if a specific staff member is responsible for moving patients out of operating rooms, as indicated by their context, then the context based data relevance determination system 602 can push data alerting to remove a patient from an operating room to the specific staff member.

In a specific implementation, the context based data relevance determination system 602 improves overall efficiency of hospitals or acute care centers. In various implementations, the context based data relevance determination system 602 improves surgical case volume by up to 20%. Specifically, hospitals and acute care centers can increase the number of patients they can handle by over 20%. In various implementations, the context based data relevance determination system 602 results in a 5-15 minute reductions in operating room turnover time, wheels out to wheels in time. The context based data relevance determination system 602 can function to improve on time starting of procedures, patient throughput, and patient turnaround times.

The example context based data relevance determination system 602 shown in FIG. 6 includes a workflow datastore 604, a context determination engine 606, a user datastore 608, a workflow traversal engine 610, and a relevant data management engine 612. The workflow datastore 604 functions according to an applicable datastore for storing workflow data, such as the workflow datastores described in this paper. Workflow data stored in the workflow datastore 604 can indicate workflows and associated contexts of users for application of the workflows. A workflow can include different decision routes and triggers or events, corresponding to contexts that cause traversal of specific decision routes. Decision routes can include activities to perform in traversing a decision route as part of a workflow. For example, a decision route can include an activity specifying to alert staff to remove a patient from an operating room. Further in the example, the decision route can include a trigger that once a context of a patient indicates that the patient is done with a procedure, the decision route should be traversed.

The context determination engine 606 functions according to an applicable engine for determining a context of user, such as the context determination engines described in this paper. The context determination engine 606 can determine contexts of users in real-time as their contexts change. For example, the context determination engine 606 can determine an ever changing context of a user as a user moves based on an applicable form of tracking a device worn by the user. Depending upon implementation-specific or other considerations, the context determination engine 606 can determine a context of a user based on feedback received from another user or a context of another user. For example, the context determination engine 606 can receive feedback from a surgeon indicating that a procedure is done being performed on a patient. In another example, the context determination engine 606 can determine that a procedure is done being performed on a patient based on a location of a surgeon in leaving an operating room.

In a specific implementation, the context determination engine 606 functions to determine a context of users by querying users. Specifically, the context determination engine 606 can ask users what their roles or specialties. For example, the context determination engine can ask a doctor what their specialties are. Depending upon implementation-specific or other considerations, the context determination engine 606 can query a patient through, e.g. a patient engagement system, to determine a context of a patient.

The user datastore 608 functions to store user data indicating contexts of users. User data stored in the user datastore 608 can be updated in real-time to reflect contexts of users as the contexts change. For example, user data stored in the user datastore 608 can be updated in real-time to indicate a current location of a user. In another example, user data stored in the user datastore 608 can be updated to change that a patient is done with surgery.

The workflow traversal engine 610 functions to traverse a workflow according to determined contexts. The workflow traversal engine 610 can determine decision routes to traverse within a workflow based on contexts of users. Depending upon implementation-specific or other considerations, the workflow traversal engine 610 can determine decision routes to traverse within a workflow based on contexts of a patient. For example, if a patient is in pre-operation, then the workflow traversal engine 610 can traverse a decision route triggered by pre-operation status. In traversing decision routes, the workflow traversal engine 610 can determine actions to perform indicated by the decision routes. For example, the workflow traversal engine 610 can determine that a staff member needs to be notified to remove a patient from an operating room.

In a specific implementation, the workflow traversal engine 610 functions to determine a workflow to traverse. The workflow traversal engine 610 can determine a workflow to traverse based on a context of a user. For example, if a patient is a 60 year old male going for open heart surgery, then the workflow traversal engine 610 can select a workflow corresponding to 60 year old males going for open heart surgery. In another example, if a patient is a 60 year old diabetic having dialysis performed on them, then the workflow traversal engine 610 can select a workflow corresponding to 60 year old diabetics having dialysis.

The relevant data management engine 612 functions to determine relevant data to push to users and instruct an applicable engine, such as the communication engines described in this paper, to push or send the relevant data to the users. The relevant data management engine 612 can determine relevant data based on actions determined by traversing a workflow. For example, if an action indicates to warn a patient that they need to take their medication, then the relevant data management engine 612 can determine that a warning should be pushed or sent to the patient. In another example, if an action indicates that a patient needs to be removed from an operating room, then the data management engine 612 can determine that an alert indicating to remove a patient should be sent to specific staff members.

In a specific implementation, the relevant data management engine 612, functions to determine relevant users to push or send relevant data to and instruct an applicable engine, such as the communication engines described in this paper, to push or send the relevant data to the relevant users. Depending upon implementation-specific or other considerations the relevant data management engine 612 can determine a relevant user based on traversal of a workflow. For example, if in traversing a workflow it is determined that a specific user needs to take an action, then the relevant data management engine 612 can determine that the specific user is a relevant user. Further depending upon implementation-specific or other considerations, the relevant data management engine 612 can determine a relevant user from contexts of a user. For example, if a context of a doctor indicates that the doctor is the only emergency room doctor available and an action indicates that an emergency room doctor needs to see a patient, then the relevant data management engine 612 can determine that the doctor is a relevant user for receiving an alert. In another example, if a context of a staff member indicates that they are the closest available staff member to an operating room and an action indicates that a patient needs to be removed from an operating room, then the relevant data management engine 612 can determine that the staff member is a relevant user.

In an example of operation of the example system shown in FIG. 6, the context determination engine 606 determines contexts of users in real-time and updates user data stored in the user datastore 608 to indicate the determined contexts in real-time. In the example of operation of the example system shown in FIG. 6, the workflow traversal engine 610 selects a workflow to traverse from workflow data stored in the workflow datastore 604 based on a context of a patient. Further, in the example of operation of the example system shown in FIG. 6, the workflow traversal engine 610 traverses decision routes within the workflow based on contexts of the patient as the contexts of the patient changes to determine actions to take. In the example of operation of the example system shown in FIG. 6, the relevant data management engine 612 determines relevant data and relevant users to send the relevant data to based on the determined actions and contexts of users. In the example of operation of the example system shown in FIG. 6, the relevant data management engine 612 instructs an applicable engine for communicating, such as the communication engines described in this paper, to push or send the relevant data to the relevant users.

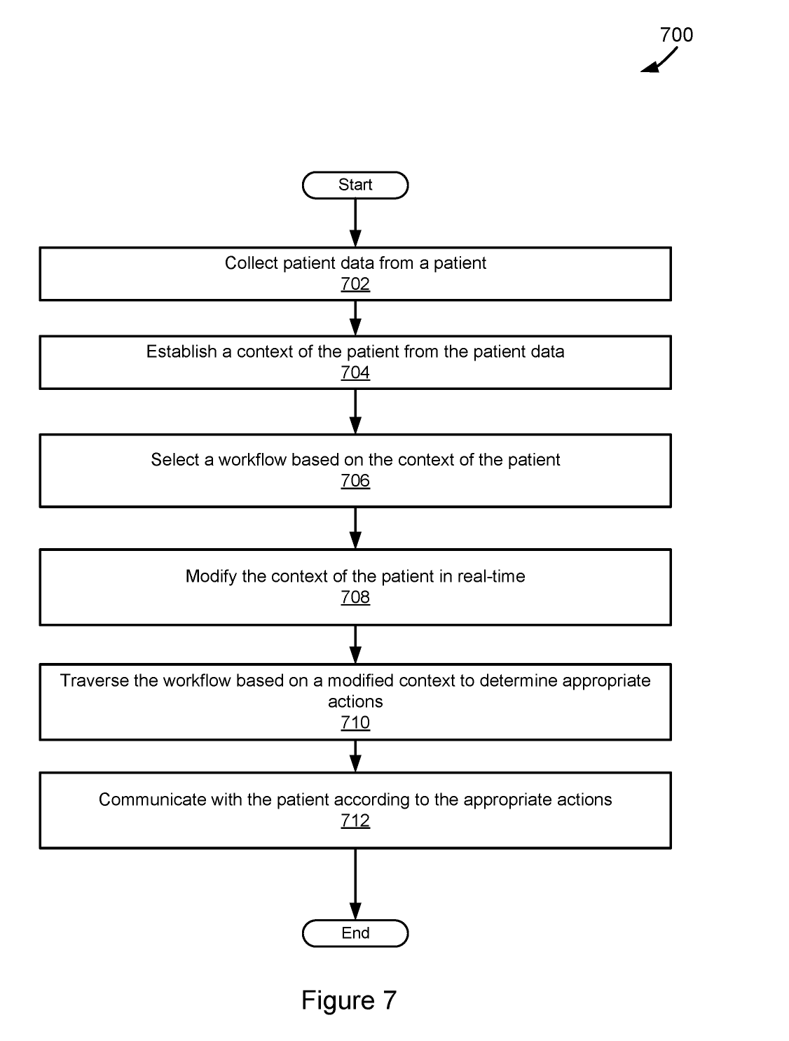

FIG. 7 depicts a flowchart 700 of an example of a method for communicating with a patient according to a changing context of a patient using a workflow. The flowchart 700 begins at module 702 where patient data is collected from a patient. An applicable engine for collecting patient data, such as the data acquisition engines described in this paper, can collect patient data from a patient. Depending upon implementation-specific or other considerations, patient data can be collected from a patient by querying the patient. For example, a patient can be asked their age and their symptoms.

The flowchart 700 continues to module 704, where a context of the patient is established from the patient data. An applicable engine for establishing a context, such as the context determination engines described in this paper, can establish a context of the patient based on the patient data. For example, if patient data indicates that a patient is a 60 year old diabetic, a context of the patient can be determined to be a 60 year old diabetic.

The flowchart 700 continues to module 706, where a workload to apply to the patient is selected based on the context of the patient. An applicable engine for selecting a workload to apply to the patient, such as the patient communication engines described in this paper, can select a workload to apply to the patient. For example, if a context of a patient is a 60 year old diabetic than a workload for treating 60 year old diabetics can be selected.

The flowchart 700 continues to module 708, where the context of the patient is modified in real-time. An applicable engine for modifying the context of the patient, such as the context determination engines described in this paper, can modify the context of the patient in real-time. In various implementations, a context of the patient changing in real-time can be determines based, at least in part, on a workflow. For example if a workflow specifies that if a patient is experiencing certain symptoms that they are having an adverse reaction to medication, and if newly received patient data indicates that the patient is experiencing the certain symptoms, the context for the patient can be modified to indicate that they are having an adverse reaction to the medication.

The flowchart 700 continues to module 710, where the workflow is traversed based on a modified context of the patient to determine appropriate actions. An applicable engine for traversing the workflow, such as the patient communication engines described in this paper, can traverse the workflow based on a modified context to determine appropriate actions. For example, if the context of the patient changes to include that the patient is experiencing specific symptoms, then the workflow can be traversed down a decision route corresponding to the patient experiencing the specific symptoms to determine appropriate actions.

The flowchart 700 continues to module 712, where the patient is communicated with according to the appropriate actions. An applicable engine for communicating with a patient, such as the patient communication engines described in this paper, can communicate with the patient according to the appropriate actions. For example, if appropriate action, as determined from a decision route in the workflow, indicate to advise the patient to seek immediate medical attention, then it can be communicated to the patient to seek immediate medical attention.

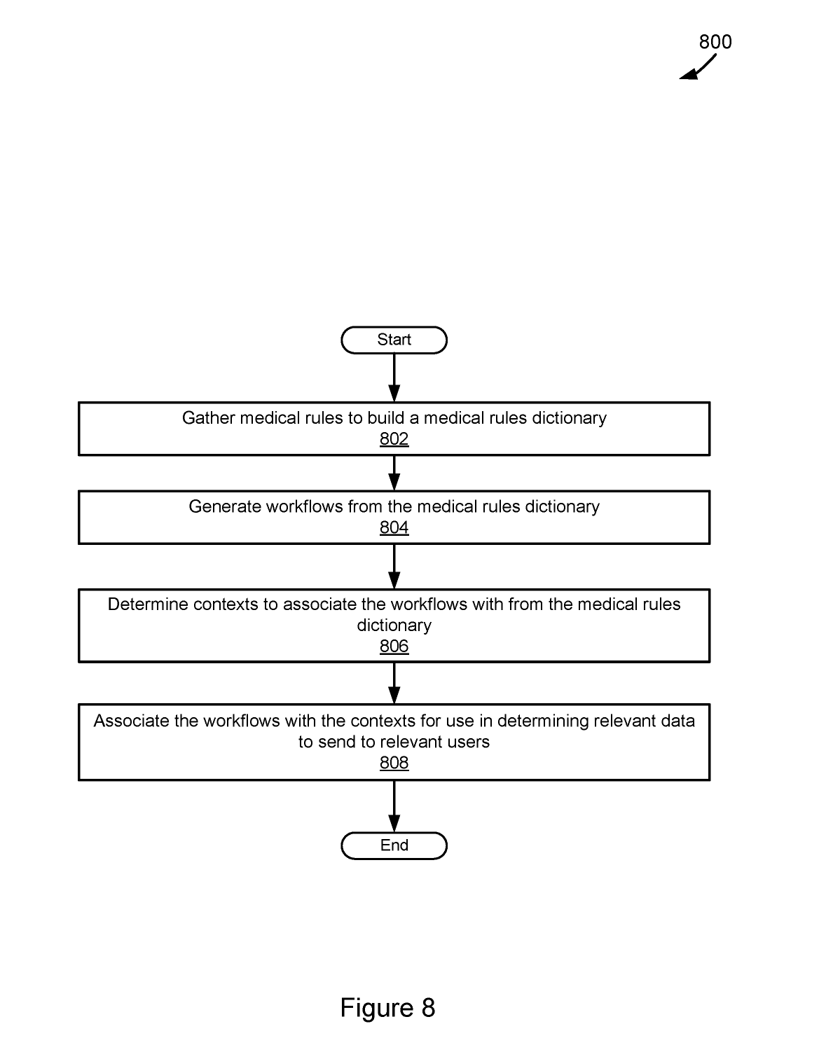

FIG. 8 depicts a flowchart 800 of an example of a method for generating workflows for use in determining relevant data to send to relevant users based on context. The flowchart 800 begins at module 802, where medical rules are gathered and a medical rules dictionary is built. An applicable engine for building a medical rules dictionary, such as the medical rules management engines described in this paper, can gather medical rules and use them to build a medical rules dictionary. Medical rules can be general medical rules attained from a general source or specific to a care provider or organization.

The flowchart 800 continues to module 804, where workflows are generated from the medical rules dictionary. An applicable engine for generating workflows, such as the workflow engines described in this paper, can generate workflows from the medical rules dictionary. For example, decision routes and conditions or events, corresponding to different contexts, that trigger traversal of the different decision routes can be determined from the medical rules dictionary. Further in the example, the decision routes and conditions or events can be used to formulate workflows.

The flowchart 800 continues to module 806, where contexts to associate the workflows with are determined from the medical rules dictionary. An applicable engine for generating workflows, such as the workflow engines described in this paper, can determine context to associate with the workflows. For example if a workflow is used to treat diabetes patients over 60, then it can be determined to associated the workflow with the context of patients with diabetes over 60 years old.

The flowchart 800 continues to module 808, where the workflows are associated with the contexts for user in determining relevant data to send to relevant users. An applicable engine for generating workflows, such as the workflow engines described in this paper, can associate the contexts with the workflows. For example, workflow data can be modified to indicate that a specific workflow is associated with a specific context.

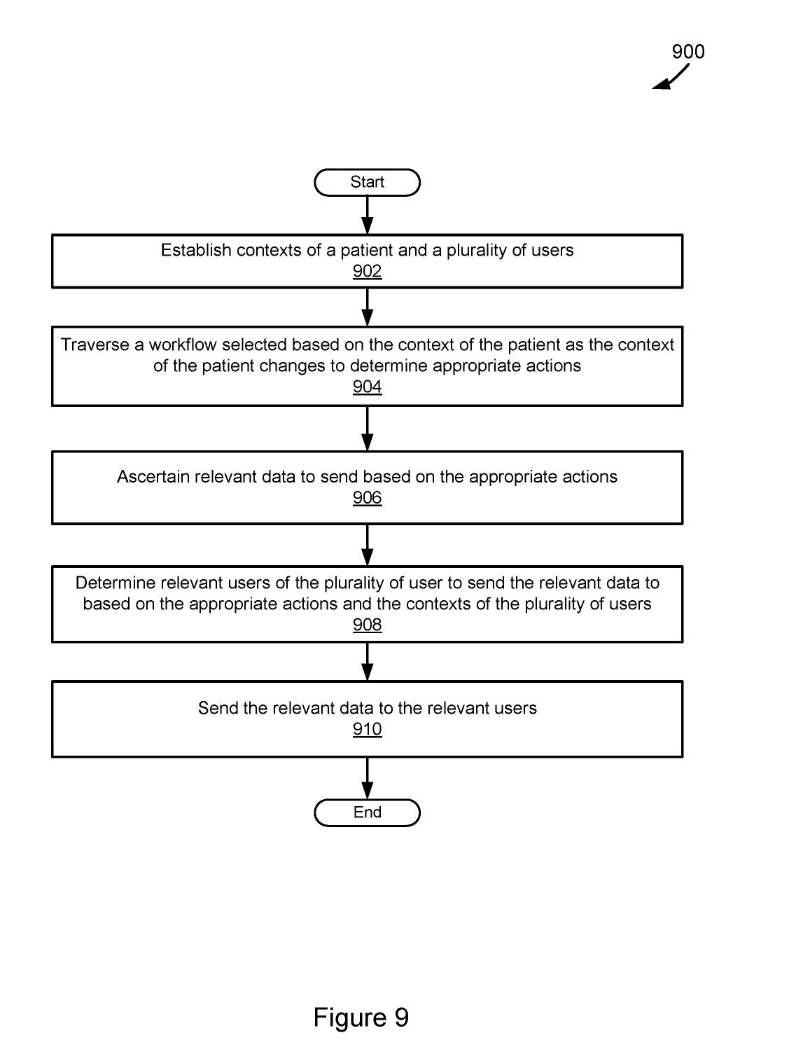

FIG. 9 depicts a flowchart 900 of an example of a method for determining relevant data to send to relevant users based on contexts of users and a workflow. The flowchart 900 begins at module 902, where contexts of a patient and a plurality of users are established. Users can include hospital or acute care center workers. An applicable engine for determining contexts, such as the context determination engines described in this paper, can establish contexts of a patient and a plurality of users. For example, if a patient is done having a procedure performed on them, then a context for the user can be established indicating that the patient is done with the procedure.

The flowchart 900 continues to module 904, where a workflow is traversed as the context of the patient changes to determine appropriate actions. A workflow is chosen based on the context of the patient. An applicable engine for choosing a workflow and traversing the workflow based on context, such as the workflow traversal engines described in this paper, can traverse a workflow based on the context of the patient to determine appropriate actions. For example, if the context of the patient changes to indicate that they are done having a procedure performed on them, then a decision route in the workflow can be traversed to determine appropriate actions include removing the patient from the operating room.

The flowchart 900 continues to module 906, where relevant data to send is ascertain based on the appropriate actions. An applicable engine for determining relevant data to send, such as the relevant data management engines described in this paper, can ascertain relevant data to send based on the appropriate actions. For example, if appropriate actions indicate to remove a patient from an operating room, then relevant data can be an alert to remove a patient from a specific operating room.

The flowchart 900 continues to module 908, where relevant users of the plurality of users to send the relevant data to are determined based on the appropriate actions and the contexts of the plurality of user. An applicable engine for determining relevant users, such as the relevant data management engines described in this paper, can determine relevant users of the plurality of users to send the relevant data to based on the appropriate actions and the contexts of the plurality of user. For example, if context of a specific staff member indicates that they are closes to an operating room, then they can be selected to receive an alert to remove a patient from the operating room.

The flowchart 900 continues to module 910, where the relevant data is sent to the relevant users. An applicable engine for sending relevant data to relevant users, such as the communication engines described in this paper, can send the relevant data to the relevant users. The communications engines described in this paper can be instructed to send the relevant data to the relevant users by a relevant data management engine.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
establishing a context of a patient and contexts of a plurality of users;
selecting a workflow based on the context of the patient;
traversing the workflow based on a changing of the context of the patient to determine appropriate actions;
ascertaining relevant data to send for coordinating activities in real-time for providing care to the patient based on the appropriate actions;
determining a relevant user of the plurality of users based on the contexts of the plurality of users and the appropriate actions;
sending the relevant data to the relevant user for coordinating activities in real-time for providing care to the patient.

2. The method of claim 1, wherein the workflow includes a plurality of decision routes that when traversed are used to determine the appropriate actions, the plurality of decisions routes including conditions that when met trigger traversal of the plurality of decisions routes, whether the conditions are met depending on contexts of the patient.

3. The method of claim 1, further comprising:
gathering initial patient data from the patient;
establishing the context of the patient based on the initial patient data.

4. The method of claim 1, wherein the contexts of the plurality of users includes locations of the plurality of users.

5. The method of claim 1, wherein the contexts of the plurality of users includes the plurality of users' roles in providing the care to the patient.

6. The method of claim 1, further comprising communicating with the patient according to the appropriate actions.

7. The method of claim 1, further comprising:
communicating with the patient according to the appropriate actions;
receiving patient data indicating symptoms the patient is experiencing in response to taking a drug, the patient data used as part of a clinical trial of the drug.

8. The method of claim 1, wherein the workflow is generated based on a medical rules dictionary.

9. The method of claim 1, further comprising:
generating the workflow based on a medical rules dictionary;
determining a context to associate the workflow with based on the medical rules dictionary;
associating the context with the workflow, wherein the context is the context of the patient.

10. The method of claim 1, wherein the context of the patient includes a step at which a patient is at in receive care at an acute care center.

11. A system comprising:
a context determination engine configured to establish a context of a patient and contexts of a plurality of users;
a workflow traversal engine configured to:
select a workflow based on the context of the patient;
traverse the workflow based on a changing of the context of the patient to determine appropriate actions;
a relevant data management engine configured to:
ascertain relevant data to send for coordinating activities in real-time for providing care to the patient based on the appropriate actions;
determine a relevant user of the plurality of users based on the contexts of the plurality of users and the appropriate actions;
a communication engine configured to send the relevant data to the relevant user for coordinating activities in real-time for providing care to the patient.

12. The system of claim 11, wherein the workflow includes a plurality of decision routes that when traversed are used to determine the appropriate actions, the plurality of decisions routes including conditions that when met trigger traversal of the plurality of decisions routes, whether the conditions are met depending on contexts of the patient.

13. The system of claim 11, further comprising:
a data acquisition engine configured to gather initial patient data from the patient;
the context determination engine further configured to establish the context of the patient based on the initial patient data.

14. The system of claim 11, wherein the contexts of the plurality of users includes locations of the plurality of users.

15. The system of claim 11, wherein the contexts of the plurality of users includes the plurality of users' roles in providing the care to the patient.

16. The system of claim 11, further comprising a patient communication engine configured to communicate with the patient according to the appropriate actions.

17. The system of claim 11, further comprising:
a patient communication engine configured communicate with the patient according to the appropriate actions;
a data acquisition engine configured to receive patient data indicating symptoms the patient is experiencing in response to taking a drug, the patient data used as part of a clinical trial of the drug.

18. The system of claim 11, further comprising a workflow engine configured to generate the workflow based on a medical rules dictionary.

19. The system of claim 11, further comprising a workflow engine configured to:
generate the workflow based on a medical rules dictionary;
determine a context to associate the workflow with based on the medical rules dictionary;
associate the context with the workflow, wherein the context is the context of the patient.

20. A system comprising:
means for establishing a context of a patient and contexts of a plurality of users;
means for selecting a workflow based on the context of the patient;
means for traversing the workflow based on a changing of the context of the patient to determine appropriate actions;
means for ascertaining relevant data to send for coordinating activities in real-time for providing care to the patient based on the appropriate actions;
means for determining a relevant user of the plurality of users based on the contexts of the plurality of users and the appropriate actions;
means for sending the relevant data to the relevant user for coordinating activities in real-time for providing care to the patient.
